(19) United States
(12) Patent Application Publication
(10) Pub. No.: US 2016/0275635 A1
(43) Pub. Date: Sep. 22, 2016

(54) EDUCATION TRANSACTION SYSTEM AND METHOD FOR MANAGING THE SAME

(71) Applicant: Christopher Charles NEL, Albinia, Durban (ZA)

(72) Inventor: Christopher Charles NEL, Albinia, Durban (ZA)

(21) Appl. No.: 14/778,421

(22) PCT Filed: Mar. 20, 2014
(86) PCT No.: PCT/IB2014/059987

§ 371 Date: Sep. 18, 2015

(30) Foreign Application Priority Data
Mar. 20, 2013 (ZA) 2013/02142

(51) Int. Cl. G06Q 50/20

(52) U.S. Cl. CPC G06Q 50/2053

(57) ABSTRACT

This invention relates to an education transaction system comprising a database storing educator data associated with an education institution such as a school, wherein the educator data comprises at least information indicative of education fees levied by the school; a selection module configured to receive an education institution nomination request, from a registered user of the system, to select a school; a cash collections module configured to receive monetary information indicative of a monetary amount associated with the registered user; a conversion processing module configured to process the received monetary information with the stored educator data associated with the selected education institution, or category thereof, to determine a number of school days, redeemable at the school, which the received monetary amount may purchase; and an associating module configured to associate the purchased school days with the registered user. The invention also relates to a method of operating said system.

### BACKGROUND OF THE INVENTION

THIS INVENTION relates to an education transaction system and to a method for managing an education transaction system.

Education costs, particularly school or tuition fees are often one of the largest expenses which have to be outlaid by/for students. Various schools, ranging from elite private schools to state funded schools, levy some form of school fees which have to be paid in order for students to attend the same. These costs, particularly for private or semi-private schools, often become problematic and burdensome especially in respect of pre-tertiary education where younger students rely on parents, guardians, organisations, etc. for provision of school fees. In the absence of adequate funds available for school fees, it is very difficult for students to be enrolled in or attend particular schools, especially private or semi-private schools which levy higher school fees than state funded schools. As a result, loans often have to be taken in view of the tuition fees payable for a particular school. Failing which, students have to try, not without difficulty, to obtain scholarships, bursaries, etc. to attend schools of choice or, resort to attending schools within available budgets, which may not be schools of preference or choice.

One conventional way in which the above problems are addressed is to institute education savings or investment plans for school fees, for example, from the time a student is born or while the student is young. However, most of these plans are often conventional savings or investment plans, for example, conventional unit trust based plans, or the like, making the same easily disposable for the monetary value thereof. In many cases, when funds are required for purposes other than for school fees, these plans may be easily “cashed in” for a monetary value which is then utilised for the other purposes, often to the detriment of the education of the student.

It is an object of the present invention at least to address the abovementioned problems and/or difficulties associated with financing education; and to provide a different manner of financing education.

### SUMMARY OF THE INVENTION

According to a first aspect of the invention there is provided A method of operating an education transaction system, the method comprising:
storing, in a database, educator data associated with an education institution, or category of education institution, wherein the educator data comprises at least information indicative of education time available and/or education fees levied by the education institution, or category thereof;
receiving education time based information indicative of an amount of time at an education institution received by the system and/or monetary information indicative of a monetary amount received by the system, wherein the received time and/or monetary amount is associated with a registered user of the system;
receiving an education institution nomination request, from the registered user of the system, to select an education institution, or category thereof;
processing the received time and/or monetary information with the stored educator data associated with the selected education institution, or category thereof, to determine a configurable time period of education service, redeemable in the future, at the selected education institution, or category thereof, which the received monetary amount may purchase and/or received amount of time may acquire;
processing payment for and/or acquisition of the configurable time period; and
associating, in the database, the purchased and/or acquired configurable time period with the registered user, wherein the purchased and/or acquired configurable time period is not redeemable for a monetary sum by the registered user.

The configurable time period may be expressed as tuition or school days at an education institution, or category thereof, the method may therefore comprise:
maintaining, in the database, a school day balance for each registered user of the system, wherein the school day balance is indicative of an accumulated number of school days at the selected education institution or school, or category thereof; and
allocating purchased school days to the school day balance.

It will be understood that, in effect, the configurable time periods, or school days, may be conceptual periods of time of education or tuition generated and maintained by the system which correspond to, and are redeemable for, corresponding periods of time, or in other words “real-world” periods of education or tuition time, at a particular selected education institutions. For example, should the school day balance in the system reflect 300 school days at School X, then 300 days of tuition or school days may be redeemable School X. The education institution may be a school, university, college, or the like.

The method may comprise converting school days from a first education institution to school days at a second education institution using stored educator data associated with the first and second education institutions, in response to a request therefore from the registered user. It follows that school days maintained in the database for a registered user may fluctuate depending on the schools selected. For example, 300 school days at School X may he equivalent to only 250 school days at more expensive School Y. The method may be configured to convert between school days at different institutions by using the respective educator data associated with the schools, which may comprise conversation factors to covert school days from one school to another.

The method may comprise purchasing education points with the received monetary amount, which points are expressible in terms of school days.

The educator data may comprise both education time provided and education fees per annum, day, term, or month at the education institution, or category thereof.

The method may comprise the step of calculating daily education fees at each education institution, or category thereof, by dividing the fees levied for a particular period by the education institution, or average fees levied for a particular period by the category of education institution, by the number of active school days in the said particular period, blended with the non-fee based time provisions of the institution, wherein the active days excludes weekends, public holidays, and breaks.

Processing the received monetary information may comprise dividing a monetary value, associated with the monetary amount received, blended with the time provision received, by daily education fees of the selected education institution, or category thereof, thereby to determine the number, or portion, of school days which the received monetary amount may purchase at the education institution (and the time provisions catered for), or category thereof.

The method may comprise the step of registering a registered user to the system and storing received information associated therewith in a registered user profile, in the database.

The method may comprise aggregating school days in the school day balance for a registered user for monetary amounts received.

The method may comprise a step of generating a voucher for school days at a particular education institution, or category thereof, on receipt of a suitable withdrawal or redemption instruction from the registered user to redeem school days.

The method may comprise debiting the registered users balance of school days accordingly and automatically transferring a monetary amount associated with the generated voucher for school days to the education institution.

The method may comprise transmitting a suitable payment advice to the education institution and optionally registering a nominated student for the number of school days as per the generated voucher.

The method may comprising receive a monetary amount associated the registered user by two or more of receiving a periodic premium from the registered user directly, receiving a monetary amount via an authorised retailer, wherein the authorised retailer apportions a portion of a spend made by the registered user to the authorised retailer to the system, interest earned on the monetary amount paid for the purchased school days, receiving a discount from the education institution, and receiving a monetary amount from a secondary registered user. Portions of profits from the use and/or operation of the system may optionally be channelled back into monetary amounts receivable by the system for a registered user. In addition, schools may provide or contribute school days to certain registered users or to all registered users, for example, of a particular type such as low income registered users.

It will be understood that a plurality of users may contribute to a school day balance as envisaged herein, for a particular beneficiary. In one example embodiment, the registered user may be a beneficiary of the school days. However, the registered user may be a primary user with other registered users registering to use the system simply to contribute school days to the school day balance.

The method may comprise receiving and storing educator data for each educational institution on a periodic basis and/or in response to an increase in fees levied by the education institutions and/or time provisions facilitated by the same.

The method may comprise:
using current educator data to determine the amount to school days held at a particular school substantially in real-time; and/or
determining inflation adjusted educator data associated with a school at a date or year of redemption of school days, using the inflated educator data to determine the amount of school days held at present associated with the date or year of redemption.

In this way, the method/system may be able to indicate the present (substantially in real-time) and/or future number of school days in the school day balance to a user. For example, 300 school days at School X in the present time may be only 250 school days at School Y due to inflation. The method may comprise including an inflation factor in the determination of the school day balance wherein the school day balance may grow via the mechanisms described herein, it may also decrease by inflation.

The method may comprise generating one or more school days in response to registered users transacting with authorised retailers, which school are accruable to the school day balance associated with the registered user.

The school day, particularly the monetary amount paid therefore, may be invested into an investment or an investment vehicle.

The method may comprise making the school day balance available for viewing by the user via a suitable user interface means, for example, accessible via the Internet by way of a website, a software application, or the like.

The method may comprise receiving a beneficiary selection from the registered user indicative of the recipient of the school days.

According to a second aspect of the invention, there is provided an education transaction system comprising:
a database storing educator data associated with at least one education institution, or category of education institution, wherein the educator data comprises at least information indicative of education fees levied by the education institution, or category thereof;
a selection module configured to receive an education institution nomination request, from a registered user of the system, to select an education institution, or category thereof;
a cash collections module configured to receive monetary information indicative of a monetary amount associated with the registered user;
a conversion processing module configured to process the received monetary and time information with the stored educator data associated with the selected education institution, or category thereof, to determine a configurable time period of education service, redeemable in the future, at the selected education institution, or category thereof, which the received monetary amount may purchase; and
an associating module configured to associate in the database, the purchased configurable time period with the registered user, wherein the purchased configurable time period is not redeemable for a monetary sum by the registered user.

The system may comprise an education registration module configured to receive and store, in the database, educator data associated with a plurality of education institutions, or categories thereof.

The configurable time period may be expressed as tuition or school days at an education institution, or category thereof, wherein:
the database may store a school day balance for each registered user of the system, wherein the school day balance is indicative of an accumulated number of school days at the selected education institution or school, or category thereof; and
the association module may be configured to allocate purchased school days to the school day balance stored in the database.

The educator data may comprise time the provisions and/or education fees per annum, term, or month at the education institution, or category thereof.

The education registration module may be operable to calculate the effective daily education fees at each education institution, or category thereof, by dividing the fees levied for a particular period by the education institution, or average fees levied for a particular period by the category of education institution, blended with the time provisions of the same, by the number of active school days in the said particular period, wherein the active days excludes weekends, public holidays, breaks, and the like.

The conversion processing module may be configured to process the received monetary information by dividing a monetary value, associated with the monetary amount received, by the effective daily education fees of the selected education institution, or category thereof, thereby to determine the number, or portion, of school days which the received monetary amount may purchase, blended with the time provisions at the education institution, or category thereof.

The system may comprise a user registration and management module operable to facilitate registering a user to the system and storing received information associated therewith in a registered user profile and/or maintain the school day balance for a particular registered user in the database.

The user registration and management module may be configured to aggregate school days in the school day balance for a registered user for monetary amounts received.

The system may comprise a redemption module operable to generate a voucher for school days at a particular education institution, or category thereof, on receipt of a suitable withdrawal or redemption instruction from the registered user to redeem school days.

The redemption module may be configured to debit the school day balance of the registered user and automatically transfer a monetary amount associated with the generated voucher for school days to the education institution advising any parties of any time provision obligations in the process.

The redemption module may be operable to transmit a suitable payment advice to the education institution and optionally register a nominated student for the number of school days as per the generated voucher.

The system may comprise an enrichment module configured to receive information indicative of a monetary amount received from a registered user via an authorised retailer, wherein the authorised retailer apportions a portion of a spend made by the registered user to authorised retailer, to the system.

The enrichment module may be operable to use the conversion processing module to generate one or more school days in response to registered users transacting with authorised retailers, the school days being accruable to the school day balance of the registered user.

The enrichment module may be configured to invest the monetary amounts received for the purchase of the school days, into one or more conventional financial vehicles.

The system may be for the pre-purchase of education services at a school, a university, and a college.

The system may comprise a user interface means configured to provide the registered user with information indicative of their school day balance in response to a received request therefor.

The system may comprise a time provision module configured to receive education provision time (capacity) from an educator.

According to a third aspect of the invention, there is provided a method comprising:
storing, in a database, a school day balance associated with school days purchased for an education institution, or category thereof, by a seller;
receiving a purchase request for purchase of school days for a particular monetary amount from a buyer;
receiving a selling request for sale of a school day for a particular desired monetary amount by the seller;
matching substantially a received purchase request and a received selling request in accordance with a predetermined rule set; and
in response to a substantial match being agreed to by the buyer and seller, processing the sale of the school days.

Processing the sale of school days may comprise the steps of debiting a school day balance of the seller in the database and crediting a school day balance associated with the purchaser accordingly, wherein the monetary amount associated with the school days debited from the school day balance of the seller is transferred into a financial account at a financial institution associated with the seller.
a conversion processing module configured to process the received monetary and/or time provision information with the stored educator data associated with the selected education institution, or category thereof, to determine a pre-paid configurable time period of human-capital based education service, redeemable in future, at the selected education institution, or category thereof, which the received monetary amount may purchase and/or time capacity provides for; and
an associating module configured to associate in the database, the purchased configurable time period at the selected education institution, or category thereof, with the registered user.

### BRIEF DESCRIPTION OF THE DRAWINGS

FIG. 1 shows a schematic illustration of a network comprising an education transaction system in accordance with an example embodiment of the invention;

FIG. 2 shows a schematic illustration of an education transaction system, in greater detail;

FIG. 3 shows a schematic illustration of an enrichment module in accordance with an example embodiment of the invention, in greater detail;

FIG. 4 shows a schematic illustration of a redemption module in accordance with an example embodiment of the invention, in greater detail;

FIG. 5 shows a schematic illustration of a trading module in accordance with an example embodiment of the invention, in greater detail;

FIG. 6 shows a high level flow diagram of a method in accordance with an example embodiment of the invention;

FIG. 7 shows another high level flow diagram of a method in accordance with an example embodiment of the invention;

FIG. 8 shows yet another high level flow diagram of a method in accordance with an example embodiment of the invention; and

FIG. 9 shows a diagrammatic representation of a machine in the example form of a computer system in which a set of instructions for causing the machine to perform any one or more of the methodologies discussed herein, may be executed.

### DESCRIPTION OF PREFERRED EMBODIMENTS

In the following description, for purposes of explanation, numerous specific details are set forth in order to provide a thorough understanding of an embodiment of the present disclosure. It will he evident, however, to one skilled in the art that the present disclosure may be practiced without these specific details.

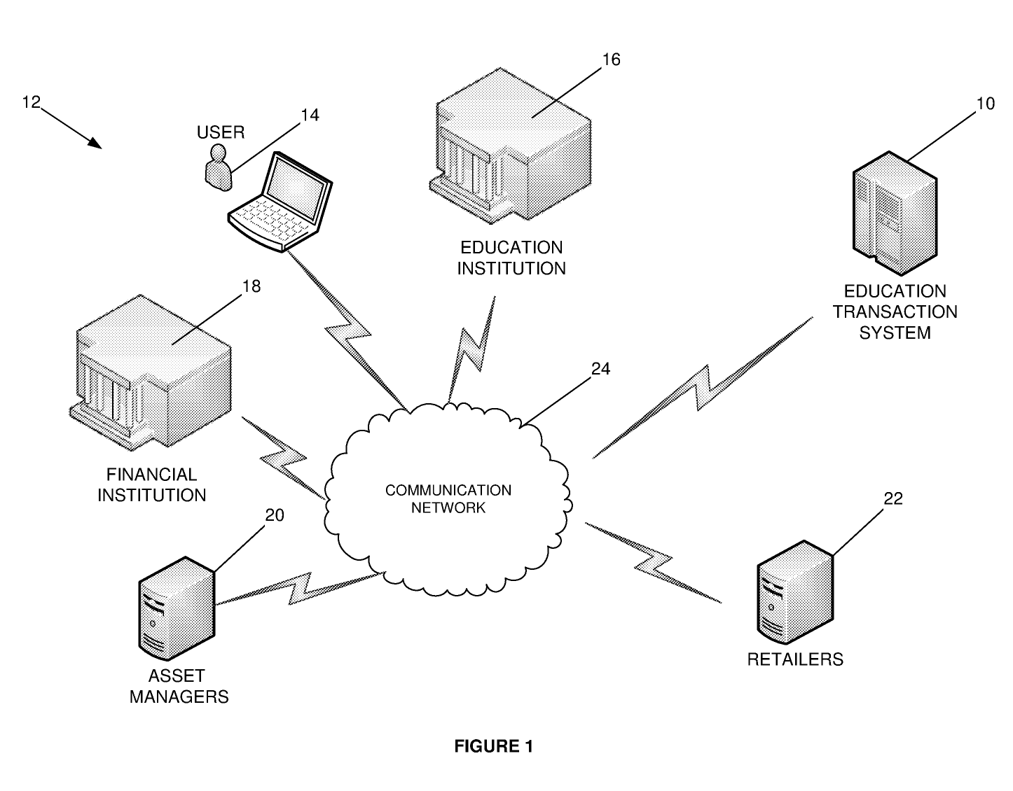

Referring to FIG. 1 of the drawings where a network incorporating an education transaction system 10 in accordance with an example embodiment of the invention is generally indicated by reference numeral 12.

The education transaction system 10 may in essence comprise an education financing system to facilitate the generation, management and control of pre-paid periods of education from education institutions or categories of education institutions as will be described below.

In this document the term “educators” and “schools” are generally intended to refer to groups and organisations of teachers, and so will be understood as such. However the invention is designed to be able to work with the group or organisation whether it consists of the plurality of teachers, or the single/individual teacher. This configurability is intended to facilitate both standard, designed, institutions, as well as looser networks of education providers be they a single founder, or an established grouping.

The system 10 is typically provided by one or more servers disposed at a single location or at multiple geographically spaced locations within the network 12. Though not discussed further, it will he noted that instead of one system 10, the network 12 may comprises a plurality of systems 10 locatable in various geographic locations, for example, in different countries, wherein the systems 10 may be independent systems or optionally communicatively coupled to each other.

Users 14, education institutions 16, financial institutions 18, asset managers 20 and retailers 22 may each communicate with the system 10 via a communication network 24. Though only one of the aforementioned is illustrated, it will be understood that a plurality of each may communicate with the system 10.

Instead of, or in addition, to the communication network 24, the system 10 may be communicatively coupled to back end computer systems associated with, for example, the institutions 16, 18, asset managers 20, and retailers 22.

The communication network 24 may be a mobile telecommunications network. Instead, the communication network 24 may be a packet-switched network and may form part of the Internet. Instead, the communications network 24 may be a circuit switched network, public switched data network, or the like. Whatever the case it will be noted that it may be possible to communicate wirelessly with the system 10 via the communication network 24.

The user 14 may be a registered user and may be a parent, guardian, organisation desiring to finance education for a nominated student. For brevity, by way of an example embodiment, the user 14 will be described herein with reference to a registered user 14 of the system with the nominated student being a child of the registered user 14.

The user 14 may communicate with the system 10 via suitable computing device such as a personal computer, laptop computer, tablet computer, smart phone, or the like connected to the network 24. In this regard, the system 10 may comprise an interface module to receive and transmit information via the network 24. The interface module may comprise a website, tablet, or phone app to facilitate interaction with the system 10. Instead, or in addition, the system 10 may be accessible or receive information from one or more agents or licensed providers of the system 10.

The education institution 16 may typically be a school, university, college, technical university, sports training institutions, or the like providing human-capital based education services and facilities for use, and optionally one or more extra-curricular activities such as sport, etc. By way of an example embodiment, the education institution will be described herein with reference to a school 16.

The financial institution 18 may be a bank while the asset managers may be one or more persons or organisations involved in the investment or management of funds. The retailers 22 may be providers for sale of goods and/or services registered with the system 10. The retailers 22 may comprise banks, service providers, etc who with whom negotiations have taken place to register to the system 10.

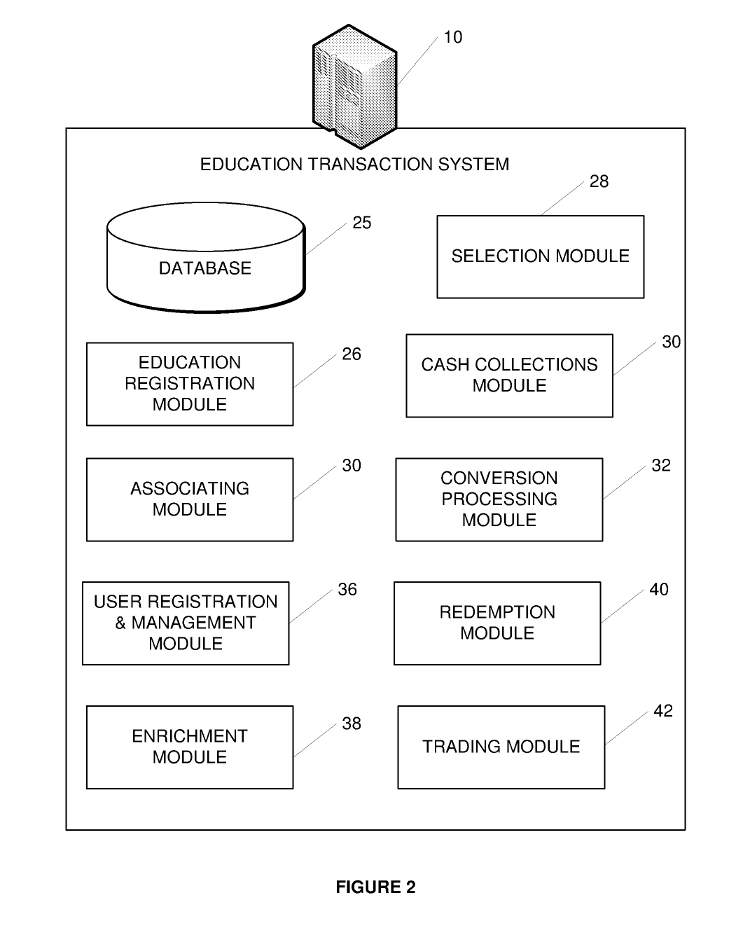

Referring now to FIG. 2, it will be noted that the education transaction system 10 may comprise a plurality of components or modules which correspond to the functional tasks to be performed by the system 10. In this regard, “module” in the context of the specification will be understood to include an identifiable portion of code, computational or executable instructions, data, or computational object to achieve a particular function, operation, processing, or procedure. It follows that a module need not he implemented in software; a module may be implemented in software, hardware, or a combination of software and hardware. Further, the modules need not necessarily be consolidated into one device but may be spread across a plurality of devices in the communication network 24 such that the system 10 may be operable to use the functionality provided by a module from within the communications network 24.

It will be noted that one or more modules described herein may be communicatively coupled to each other and also directly to the network 24 to communicate data. In addition, some modules may overlap in functionality as the case may be but are described separately for ease of description of the invention. Those skilled in the field of invention will appreciate that this will not detract from the invention described herein.

The system 10 comprises database 25 storing educator data associated with schools 16, or categories of schools 16. The educator data comprises at least information indicative of education fees levied by a school 16, or category thereof, for a particular period of time, for example, for a school day (cost per school day as described below), for a school term, annually, or the like, and or time provided non-financially by the school

In an example embodiment, schools 16 having similar average annual school fees may be grouped together in a particular category of schools 16. The categories of schools are useful for registered users 14 who aren't sure of the particular school 16 they want their children to attend but notwithstanding the same have, for example, a general idea of the average subscription fees they are willing to spend (explained below), the types of school they want their children to attend (private, semi-private, or schools with particular rating for sport or academic results, etc.), types of average costs they are willing to shoulder in school fees for a particular period of time (e.g., annual school fees, etc.), and the like. In some example embodiments, each category of school 16 may be structured in a tiered manner, for example, category 1 would comprise premier private schools, category 2 would comprise private schools, category 3 semi-private schools, and the like. Each category may have an associated costing associated therewith. The costing for each category may be provided to a user 14 for selection via the website upon registration of the user 14 to the system 10 as described below. It follows that the system 10 may continuously maintain the categories on information received thereby.

The system 10 may comprise an education registration module 26 configured to receive and store, in the database 25, educator data associated with a plurality of schools 16, or categories thereof. The schools 16 may have representatives (or intermediaries) which register the schools 16 to the system 10 using the module 26 via the website described earlier. The module 26 may, via the website, prompt the representatives or back-end computer systems of schools 16 for information, which the module 26 then receives and stores as part of the educator data for a particular school 16. Information received by the module 26 may comprise the school address, map location, GPS co-ordinates, current fees per grade (which may be updatable on the system 10 manually or automatically), average annual increase in school fees over the last 5 years, information indicative of acceptance of terms and conditions by the school 16 to use the system 10.

The education registration module 26 may effectively generate and store in the database 25 profiles of each school 16 registered with the system 10 with each profile having educator data associated with the school 16 associated therewith. The system 10 may therefore be configured to determine the categories of schools available for selection by a registered user 14.

The education registration module 26 may be operable to calculate the education fees levied per day at each school 16, or category thereof, by dividing the received current school fees levied for a particular period by the school, or average fees levied for a particular period by the category of school 16, by the number of active school days in the said particular period, blended with the pure time provisions of the parties, wherein the active days excludes weekends, public holidays, breaks, and the like. In other words, based on the received information indicative of school fees levied by a particular school 16 registered to the system 10, the module 26 is configured to determine a cost per school day for each registered school 16, or category thereof. It follows that the educator data may therefore comprise education fees per day at the education institution, or category thereof, or cost per school day for each registered school 16, or category thereof.

Registered schools 16 may be interacted with annually by the system 10 via module 26. In this interaction, several clarification and/or verification variables are to be established:
The operating legitimacy of the school 16
The current fees per learner required by the school 16 (per grade/year too, if appropriate)
Negotiable discounts available to the system 10 in this process of assisting with cash flows
The term/period of applicable fees and/or discounts
Agreeable annual escalation rates where applicable
Time (capacity) provided by the school which is not financially related/chargeable

In any event, the system 10 comprises a selection module 28 configured to receive an education institution nomination request, from the registered user 14 of the system 10, to select a school, or category thereof, at which they desire their child to be educated at. The system 10 may receive a selection via the website in response to prompting the user 10 for a selection via the website, for example, via a registration process as will be described below.

The system 10 further comprises a cash collections module 30 configured to receive monetary information indicative of a monetary amount received from the registered user 14. The monetary amount may be a subscription fee which the registered user 14 pays, for example, monthly to the system 10, based on the selected school 16, or category thereof, received by the selection module 28. The system 10 may facilitate a debit order transaction to receive the subscription fee from a bank account associated with the registered user 14. The module 30 may facilitate a discount for registered user's self-originated scheduled payment (EFT) setup (old ‘stop-order’ system). This is the preferred method of the system 10 receiving the subscription fee. The subscription fee may be received in lieu of purchase of a period of time at the selected or nominated school, or category thereof, as will be described below.

It will be noted that penalty fees for failed debits will be passed back to the registered users 14 (if there are any). In addition, failed debits are notified.

The system 10 also comprises a conversion processing module 32 configured to process the received monetary information with the stored educator data associated with the selected school 16, or category thereof, to determine a period of time at the selected education institution, or category thereof, which the received subscription fee may purchase. In particular, the module 32 is configured to divide a monetary value, associated with the subscription fee received, by the cost per school day of the selected or nominated school 16 thereby to determine the number, or portion, of school days which the received subscription fee may purchase at the selected school 16, or category thereof. In some example embodiments, the number of school days per subscription fee received is predetermined, the module 32 may therefore retrieve such information (e.g., as stored in the database) in order to determine the number of school days purchased.

The purchased school days may in effect be certified, tradeable instruments generated by the system 10. A purchased school day is a combination of a unit of time that has a financial value equivalent to one day of tuition at a registered school, but is deemed to be an asset, in terms of the system 10, which is transferable in the holder's hands (registered user 14) between schools 16. It will be appreciated that the purchased school days are only redeemable for learning time for a nominated learner or student at schools 16 registered with the system 10 as will be described below.

The system 10 also comprises an associating module 34 configured to associate in the database 25, the purchased period of time or purchased school days at the selected or nominated school 16, or category thereof, with the registered user 14. In this way, users 14 may in essence pre-pay for education at nominated schools 16, or categories thereof. In other words, the users 14 may pre-pay school fees at the nominated schools 16, or categories thereof, which is redeemable at a point in the future.

The system may comprise a user registration and management module 36 operable to facilitate registering a user 14 to the system 10 and storing received information associated therewith in a registered user profile generated by said module 36 and stored in the database 25.

The user registration and management module 36 may be configured to maintain a school day balance or account for a particular registered user 14 in an associated user profile. To this end, the user registration and management module 36 may be configured to aggregate school days in the school day balance for a registered user 16 for each subscription fee received. In addition, the user registration and management module may be configured to maintain one or more school day balances or accounts for a registered user 14, for example, the user 14 may have school day balances associated with each nominated student (e.g., each one of the registered user's children).

The module 36 may be accessible in effect via the website which the user may use to enter data which the system 10 prompts the same for in order to register the user. The module 36 may therefore receive information indicative of:
personal details associated with the user, for example, name, date of birth, contact details, address, banking details, etc.
the subscription amount they are requesting which may be determined in response to the module 36 providing options of schools 16, or categories thereof, for selection by the user and providing estimate subscription fees for each
their selected method of payment—be it financial or time (capacity) based
the child(ren) for whom the school days will be nominated
their preferences with regard to the investment of the subscription fee as will be described below
the school Category (if they don't know the specific school)
the school with which they would like their school days to be aligned (if they know it)
users 14 can elect to accelerate their school days growth with extra, single payment, acceleration fees—non-subscription based fees
registration fees are chargeable by licensed providers
subscribers can also elect to give a supplementary, benevolence-focussed subscription (not converted to school days but are held for other purposes)

In one example embodiment, not discussed further, the subscription fee may be calculated based on the information received by way of the module 36 as opposed to a pre-calculated subscription fee. The subscription fee may be calculated based on several factors, including the geographic location of the user 14, or (preferably) their nominated child, which factors in the schools 16 in the proximity to the registered address, their average fees, and the average spending and investment habits of the other users 14 in a useful radius of the user's geographic location. The website may provide a graphical user interface with selection tools comprising slider controls operable to receive inputs from a user 14 for calculation of the subscriber fee. In this way, the user 14 is conveniently informed of what their expectations can be in terms of the subscription fee based on the tools provided thereto via the slider controls. Inputs received from the user 14 via the slider controls are used as input mechanisms to calculate the aggregated user intended effect of integrating the instruments, on the ‘expectable’ bursary size (i.e. school days balance at the nominated institution 16), and in so doing, they can ‘set’ the subscription level they want.

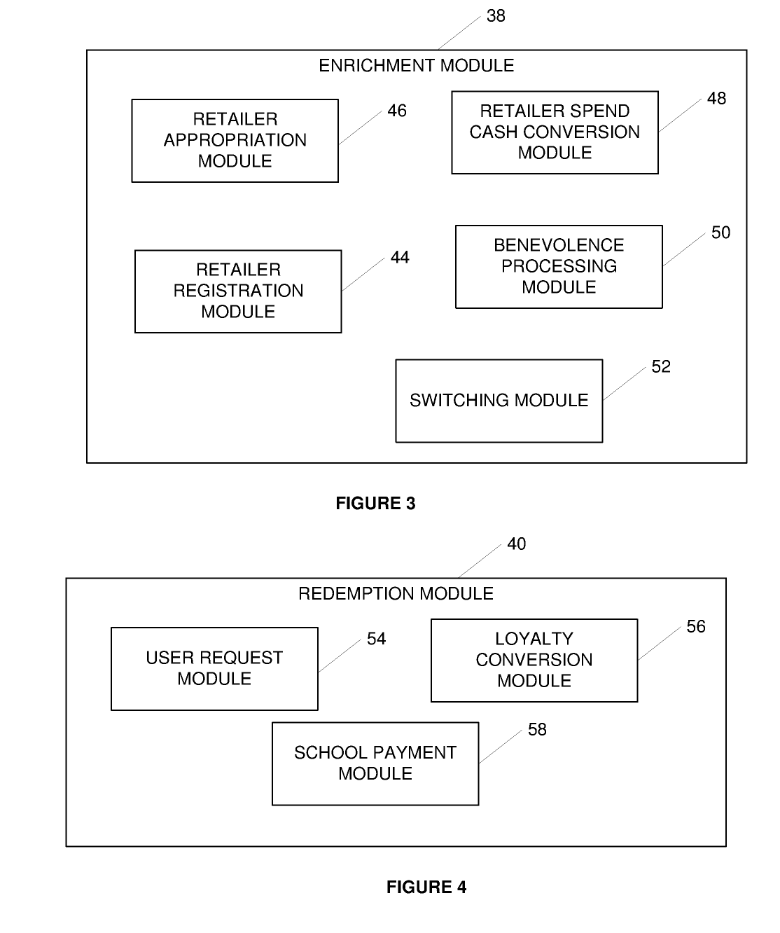

The school day balance effectively stored in the database 25, or the financial amounts associated therewith, may be processed by an enrichment module 38 according to preferences received from the user 14 via the module 36. Though the module 38 will be described in greater detail below with reference to FIG. 3, it will be noted that the module 38 is configured to receive information indicative of a monetary amount received from a registered user via an authorised retailer 22, wherein the authorised retailer 22 apportions a portion of a spend made by the registered user 14 to authorised retailer 22 to the system 10.

The enrichment module 38 may be operable to generate one or more school days in response to registered users 14 transacting with authorised retailers 22. These will accrue to the users school day balance.

The enrichment module 38 may be configured to link the school day, particularly the financial amount associated therewith, to one or more conventional financial products.

The system 10 may comprise a redemption module 40 operable to generate a voucher for school days at a particular school, or category thereof on receipt of a suitable withdrawal instruction from the registered user 14. The voucher may be one or more of a physical voucher, a software token, or the like acceptable by schools 16 registered to the system 10.

In some example embodiments, the redemption module 40 may also be configured to debit the registered user balance of school days, in the database 25, and automatically transfer a monetary amount associated with the school days as part of the withdrawal instruction, or generated voucher for school days, to the nominated school 16, for example, to a nominated financial account associated with the school 16. Any redemptions done that incorporate the use of time based acquisitions of school days, require that the time provisions facilitated by either the school or the registered user, are therefore required to have been fulfilled, or have to be fulfilled. This will be represented on the voucher.

The redemption module 40 may be operable to transmit a suitable payment advice to the school 16 and may optionally register a nominated student for the number of school days as per the generated voucher. The redemption module 40 will be discussed further below.

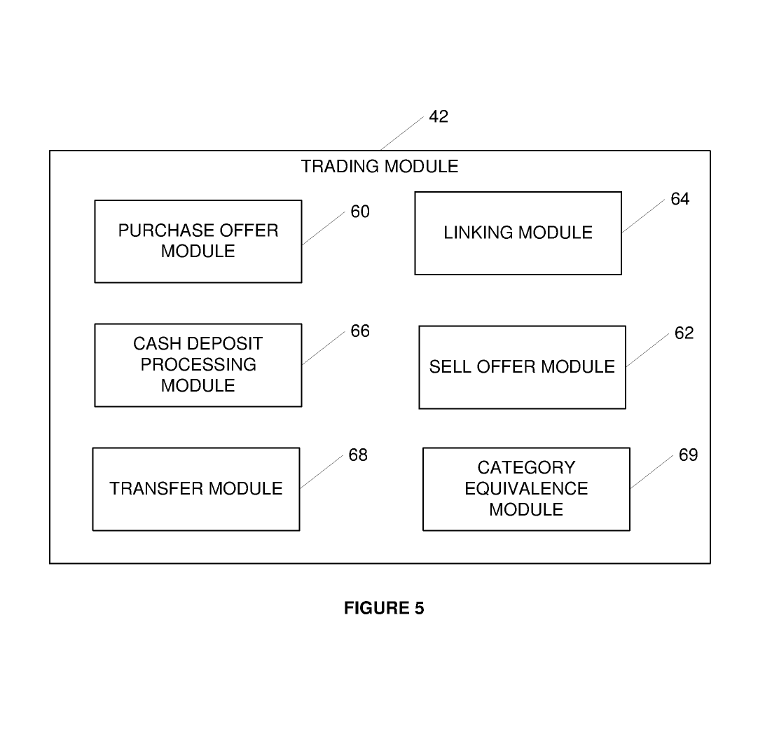

The system 10 also comprises a trading module 42 which registered users 14 may utilize to exchange or trade school days with other registered users 14. The trading module 42 is discussed further below with reference to FIG. 5. The trading module 42 may be used, for example, in a scenario whereby a user 14 registers or takes out a subscription for use of the system 10 having children. As their life unfolds, the registered user 14 never has children and then they may see no value in purchased school days or school days acquired. Since the school days are not redeemable for cash the registered user 14 may wish to sell them to some other willing buyer.

In FIG. 3, the enrichment module 38 is illustrated in more detail to comprise a plurality of sub-modules corresponding to the functionality of the enrichment module 38.

In particular, the module 38 comprises a retailer registration module 44 operable to register retailers 22 to the system 10, similarly as described above in an online manner by way of, for example, licensed operators of the system 10. The retailers 22 will have profiles generated therefore and stored in the database 25 and negotiated retailer contributions are recorded (e.g. Card, EFT set-ups, lead fees, etc) in their varying maximisation continua (e.g. volumes based rebates growth, etc). The module 44 facilitated the establishment and recording in the respective retailer profiles, co-branding and brand utilisations agreements, retailer appropriation mechanisms are to be established (e.g. Card, EFT set-ups, lead fees, etc). Traceability of user utilisation (spend) is to be provided for, for reconciliation/school days creation purposes. The module 44 received and stores information indicative of geographic locations of the retailers 22, which locations are mappable for user assistance purposes.

The module 44 feeds into a retailer appropriation module 46 in terms of an enrichment process provided by the module 38. The module 46 enables a registered user 14 to view registered retailers online via the website, or other tablet and/or smartphone tool, and understand their provisions net of the licensed operator's margins. The licensed operator may be understood to include any entity licensed by the system 10 to supply and trade purchased school days.

The module 46 enables registered users 14 to select the registered retailers 22 they wish to appropriate and in so doing, ‘order’ the appropriation mechanisms (e.g. Card, EFT set-ups, lead fees, etc). In one example embodiment, the registered users may set up their monthly budget through the facility if it maximises the generation of school days. This budget management facility automates the management of pre-paid retailer offerings, maximising a registered user's 14 purchasing of school days.

The module 46 feeds to a retailer spend cash conversion module 48. Module 48 receives information indicative of user 14 monetary spend money with the appropriate selected retailers 22, and cash resulting from spend, from the retailers 22. The module 48 is configured to reconcile the cash, utilisation (spend) reporting, and the registered user's 14 appropriation requests received via module 46.

The module 48 is operable to deduct a fraction of the earnings from the retailers 22 as income to the system 10.

In one example embodiment, purchased school days may be held in one of two types of selectable Value Growth Programmes (namely Type A or Type B) processed or facilitated by way of the module 38. Through this processing only school days that are based on direct financial acquisition methods (such as cash purchases or retailer purchases) can be processed. Other school days based acquisitions based on time contributions from either schools, or registered users cannot be processed through this module:

Type A: “A” stands for “Above the Line.” In this case the “line” represents a risk threshold. School days in the “above the line” programme are those that can both increase and decrease in volume value owing to the fact that they are linked to ongoing market assets trading (property, equities, funds managed by asset managers 20, etc). Users 14 choose this for their school days of their own, informed volition.

Capital growth in terms of Type A is based on performance in equities/properties/etc markets with subordination-based allocation rules for the growth achieved. The system 10 keeps a performance fraction of the growth. The calculation of additional “school days for availability” for allocation is made based on:

a) Preferences from the user registration via module 36

b)

c) A smoothing mechanism may be used for accumulating the growth prior to distributing it, then establishing what the “promise-able” amounts are for the next period ahead, and only then progressively allocating (reliably) according to that “promise” for the respective period. During this period, the (unpromised) growth for the next promise period is taking place simultaneously.

d) Additional school days are then allocated to the subscriber's account according to the fulfilment of rules in the designed Type A Value Growth Programme.

Type B: “B” Stands for “Below the Line.” school days in the “below the line” programme are those that won't reduce their volume value but can increase it, albeit slowly, owing to the fact that they are not linked to trading market conditions, but only risk-free environments such as money market and/or long term bond markets. This is the default or ‘base’ account in which school days are held for which users 14 are not choosing Type A. Users 14 will only be aware of Type B as a default choice.

The method of capital growth in terms of Type B is interest/bond yields, etc is earned+the account value is increased.
The licensed provider takes a fixed small fraction of the growth.

The calculation of additional “school days for availability” for allocation is made based on:

Registration of users 14 to the systems 10 viamodule 36 as described above

Additional available school days are then allocated to the subscriber's account according to the fulfilment of rules in the designed Type B Value Growth Programme.

Unallocated value (cash or assets) in either programme belongs to the licensed provider until it is allocated to balance of school days in the user's profile in the database 25. The school days are the property of the registered or subscribing users 14. Once the property of a user 14, additional school days that have been acquired through the module 38 are regarded in exactly the same way as school days that were initially acquired through the purchasing via the subscription fee as described above.

The module 38 also comprises a benevolence processing module 50 configured to process funds received from users 14 who are participating in the donation subscription for charitable purposes for growth thereof as described below.

Collections for donations acquire size-relative equivalent proportions of market instruments as the school days in the Type A Value Growth Programme. Growth from these market assets is allocated to the user's “school days for availability” balance, wherein the school days for availability are school days that could possibly be allocated to a balance of school days of a user 14 but has not yet been allocated and not yet the possession of the user 14. While growth is dealt with by the module 38 as described above, the principle capital is retained for community distribution purposes. The growth is also distributed/allocated according to different rules between the Licensed Provider, fund managers, and user 14, which benefit the user 14 most. The tax benefits, if any, of this mechanism are also to be included for user 14.

As mentioned, the management of donations received and operating of funds may be handled in an automated fashion by way of the module 50.

The module 38 also comprises a switching module 52 which is operable, on receipt of a suitable instruction, from the user 14 to switch between value growth Types A and B.

It will be noted that switching may be done in one of three ways:

1) Adjusting the default allocation of school days to the programmes as part of the registration of the user 14 to the system via module 36.

2) Receiving a switch request from the user 14 for some or all of the school days to move from one programme to the next, in either a singular bulk, or regularly-scheduled incremental amount. This type of switch will attract a small switching fee in order to accommodate the charges required by the asset managers 20.

3) A user-chosen combination of 1) and 2) above.

Switching fees can be charged by the Licensed Provider.

It will be appreciated that, in effect, the enrichment module 38 is a processing module that enables registered users 14 to grow their existing purchased school days by mechanisms alluded to above.

In FIG. 4, the redemption module 40 is illustrated to comprise is illustrated in more detail to comprise a plurality of sub-modules corresponding to the functionality of the enrichment module 40.

Firstly, it will be appreciated that school days are not redeemable for cash. They can only be redeemed for time. In one example embodiment, the school days may effectively be, or may be redeemable for, vouchers, virtual or otherwise for education at a particular school 16.

Users 14 may redeem some or all of their ‘vouchers’ (i.e. school days) any and every month if they so wish. The only requirement is that they be in possession of them in order to redeem them. They cannot therefore request redemption on ‘future’ school days (i.e. vouchers) that they do not possess yet, and for which there has not already been a transaction, be it through the subscription purchases described above or via the enrichment module 38 as hereinbefore described.

In any event, the module 40 comprises a user request module 54 configured to receive a withdrawal instruction or request from the user 14 for school days in their possession.

In this their withdrawal instruction, if the user 14 has not done on already, they need to nominate both:
the registered school 16
the learner(s) enrolled at the school 16

School days cannot be redeemed on the basis of school category pricing alone.

By way of example, in one embodiment, the module 54 may prompt the user 14 (e.g., via the website in response to receipt of the withdrawal instruction) for, and receive from, information indicative of a selection of:
volume of school days to be redeemed
The timing and frequency/recurrence of this volume of redemption (e.g. single-occasion redemption, monthly redemption, etc)
The term if there is requested recurrence.
The combination of Type A or Type B Value Growth Programme school days to be redeemed if the user 14 has sufficient availability of both.

During this selection process outlined above, the module 54 may be operable to provide real-time feedback as to the estimated effective “bursary” size (%) (i.e. package of school days) in which this set of request choices will result.

This is to be done factoring in:
the learners' ages
estimated years of schooling left
current and future estimated fees of the nominated institution(s)
the Licensed Providers costs in redeeming the school days.
These costs are to be limited to incremental cost fees of the process only, such as switching fees if any are required, bank transfer fees, and telecoms charges, etc

The module 40 also comprises a value growth conversion module 56 to process the aforementioned Value Growth Programmes. The value growth is measured only in the calculation of additional school days during the enrichment processes as described above. It will be understood that the “Value Growth Programme” in terms of the present disclosure refers to the conventions and or methods by which the system 10 allocates growth to the user's school days by virtue of the fact that they've not redeemed (spent) them over a particular period of time, and have stayed loyal to the system 10 by not ceasing their subscription.

It will be noted that only school days in Type B Value Growth Programme may be used by the module 40 for redemption purposes described herein.

Therefore, in each consideration of redemption, a switch first needs to be made, for example, via module 52, of the minimum number of school days in Type A Value Growth Programme to Type B Value Growth Programme if there are insufficient school days in Type B Value Growth Programme to meet the received withdrawal instruction of the user 14.

In the event that Type A Value Growth Programme school days are being requested for redemption as well, and there are sufficient Type B Value Growth Programme school days, the entire redemption of school days still to take place from the Type B pool of school days, which is then replenished with the number of Type A school days appropriate to the proportions required for the whole redemption as envisaged herein to be compliant.

The module 40 also comprises school payment module 58 configured to process payment to a nominated school 16 automatically on actuation thereof subject to the verification steps below.

A school days based “Bursary” (or voucher as it has been referred to previously) from the Licensed Provider can only be used at a registered school 16. To this end, the module 58 may be configured to verify, with respect to the nominated school 16:
Its legitimacy (unless this is pre-established)
That the nominated learner has been enrolled
The learner's reference/student/account no's
The current fees required by the institution

On the basis of the frequency of requests stipulated by the user, the module 58 converts the least number of school days in the user's school day account, using the required fees and other negotiated variables as conversion factors, into a cash value.

The module 58 is then operable to transfer this cash value from the Type B Value Growth Programme cash bank facility, to the school 16 as a school-fees payment on behalf of the requesting user 14, using the student's relevant student/school account number as a reference for the payment.

The module 58 then waits for receipt of acknowledgement by the school 16, of this payment. The module 58 may prompt the school for acknowledgement if not received.

The module 5 is configured to reduce the number of school days in the user's possession (i.e. ‘account’) by the number that was redeemed as described above.

The module 58 is then configured to generate and transmit a communication to the user of the successful transactions, and remaining number of school days and consequential state of the bursary in their possession.

It will be noted that the conclusions of the redemption of school days for users takes place under 3 conditions:

a) The redemption request is a single-event request, and the number of school days requested for redemption have been redeemed at the nominated school 16.

b) The recurrence term of the redemption request is completed.

c) The number of school days a user 14 owns is depleted and there are no further school days available for redemption.
In this instance, communication with the user 14 to inform them of the status is required.
The ability to make additional redemption requests or withdrawal instructions is to be blocked until there are additional school days available to redeem.
In the instance of calculable short-falls of school days looming for the user 14, in relation to their redemption request (be it recurring or otherwise), notification communication to the user 14 in advance of the depletion must be made.

It will be appreciated that the module 40 should he actuated by the system 10 if the school days in a user's possession amount to 100% funding of the remaining school days calculable for the nominated learner(s). The decision to redeem; however, remains that of the user 14, unless agreed upon previously.

In FIG. 5, the trading module 42 is illustrated to comprise is illustrated in more detail to comprise a plurality of sub-modules corresponding to the functionality of the trading module 42. The trading module 42 may in effect provide an exchange or platform for trading of generated or purchased school days between registered users 14 of the system 10.

The trading module 42 comprises a purchase offer module 60 configured to receive a purchase offer from a proposed purchaser of school days. Users 14 may register a purchase request via the website. In this module, only school days that have sufficient cash and/or other investment market backed asset base will be available for trading. The purchase offer may comprise:
The number of school days they wish to purchase. Included in these school days will be the details of the school days category, or nominated school, etc
The price per school day they are prepared to pay for the school days
A deposit of cash from the purchaser is required in order to effect the transaction, which will be held in a trust account with a partner bank 18. The bank 18 holds the transferred cash to facilitate any successful transaction.
Identity verification checks are to he in place in order to ensure the security of the purchaser.
Deal ‘tolerance’ levels or rule are set to facilitate automated transacting if the linking module (described below) finds acceptable matches.

The trading module 42 also includes a sell offer module 62 configured to receive a sell offer from a proposed seller of school days. Users 14 may register any or all of their school days for sale via the website, or an exchange/online trading portion of the website.

The sell offer may comprise:
The number of school days they wish to sell. Included in these school days will be the details of the school days category, or nominated school, etc
The price per school day they wish to receive for their school days
Users 14 entering/browsing the website will be able to see the offers to sell, but with anonymity for the users 14
Identity verification and authorisation checks are to be in place for the sellers.
Deal ‘tolerance’ levels or rules are set to facilitate automated transacting if the linking module (described below) finds acceptable matches.

The module 42 also comprises a linking module 64 configured to link or substantially match suitable purchase and sell offers.

The linking module 64 employs a ‘closest match’ logic methodology and than provides automated communication to the respective parties of the possibilities of the progress of their requests/offers.

If they are inside of the ‘automatic tolerances’ the linking module 64 automatically conducts the transaction, if all conditions of the sale have been met.

If the matches are outside of the ‘automatic tolerances’ then the module 64 notifies the respective parties of the match, and they are then left to make a decision. If they decide to take up one another's respective offers, then the linking module 64 is operable to facilitate the conducting of the transaction with relevant identity and security checks. If they do not decide to take up one another's offer, then the linking module 64 is operable to continue evaluating new offers to sell and requests/offers to purchase, until it does find an appropriate match, or the requests and/or offers are withdrawn.

The module 42 comprises a cash deposit processing module 66 configured to deposit funds or cash into nominated bank accounts of users 14 who have successfully sold their school days by way of the module 42. The module 66 is configured to notify users 14 of a successful transaction and the net sum of cash due to them prior to the deposit.

The module 66 is configured automatically to inform the corresponding relevant nominated schools of the transaction, if there are any nominated schools, and/or learners.

The module 42 further comprises a transfer module 68 configured to issue ownership of purchased school days and credit school day accounts of users 14 who have successfully purchased school days via the module 42. The module 68 is configured to generate and transmit to the purchasing user 14, an ownership certification message.

The module 68 is configured automatically to inform the corresponding relevant nominated schools of the transaction, if there are any nominated schools, and/or learners.

The module 42 further comprises a category equivalence module 69. It will be noted that the school-day is a nationally and internationally tradeable asset. The module 69 therefore facilitates the commonalising of school days value on an international basis.

For example, a “Category 4” school day in South Africa might be the equivalent of a “Category 3” school day in the United Kingdom, but a “Category 6” school Day in Saudi Arabia. Being able to “translate” between these category-equivalences means that Licensed Providers' school days based Bursaries can be usable both nationally and internationally.

In order to determine equivalent categories internationally, the module 69 may be configured to receive:
Current foreign exchange trading rates
International trading transaction fees

The module 69 enables the international commoditisation and transferability of the school days instrument.

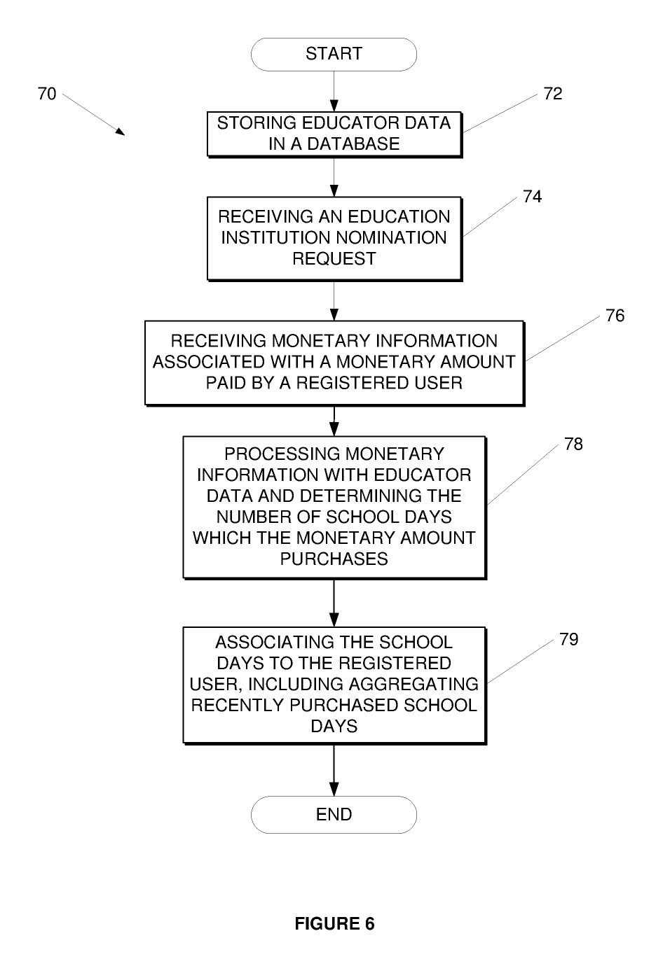

Example embodiments will now he further described in use with reference to FIGS. 6 to 8. The example methods shown in FIGS. 6 to 8 are described with reference to FIGS. 1 to 5, although it is to be appreciated that the example methods may be applicable to other systems (not illustrated) as well. The methods described herein may be computer implemented methods. The system 10 described herein may therefore comprise a non-transitory computer readable medium storing a set of instructions which when executed by a computing device causes the same to provide the system 10 or carry out the method steps as herein described.

Referring to FIG. 6 of the drawings where a high level flow diagram of a method in accordance with an example embodiment is generally indicated by reference numeral 70.

The method 70 may be a method for financing education or operating an education transaction or financing system 10. A parent may initially register to the system 10 and become a registered user 14 thereof to facilitate the funding of the education of their child.

The method may therefore comprise a prior step of registering the parent by way of the website and module 36 as hereinbefore described.

The method 70 may comprise the step of storing, at block 72, in a database 25, educator data associated with at least one school 16, or category of education institution, wherein the educator data comprises at least information indicative of education fees levied by the school, or category thereof in a manner as hereinbefore described.

The method 70 comprises receiving, at block 74 via module 28, an education institution nomination request, from a registered user 14 of the system 10, to select or nominate a school 16, or category thereof at which they desire their child to attend or be educated at.

The method 70 may comprise receiving, at block 76 via module 30, monetary information indicative of a monetary amount received from the registered user 14. The monetary amount may be a monthly subscription fee selected by the user 14 during registration and may be based on factors such as the school 16 or category of school which the parent desires their child to be educated at.

The method 70 may comprise processing, at block 78 via module 32, the received monetary information with the stored educator data associated with the selected school 16, or category thereof, to determine the number of school days at the selected school 16, or category thereof, which the received monetary amount may purchase.

The method 70 then comprises associating, at block 79 in the database 25 via module 34, the purchased school days at the selected school 16, or category thereof, with the registered user 16.

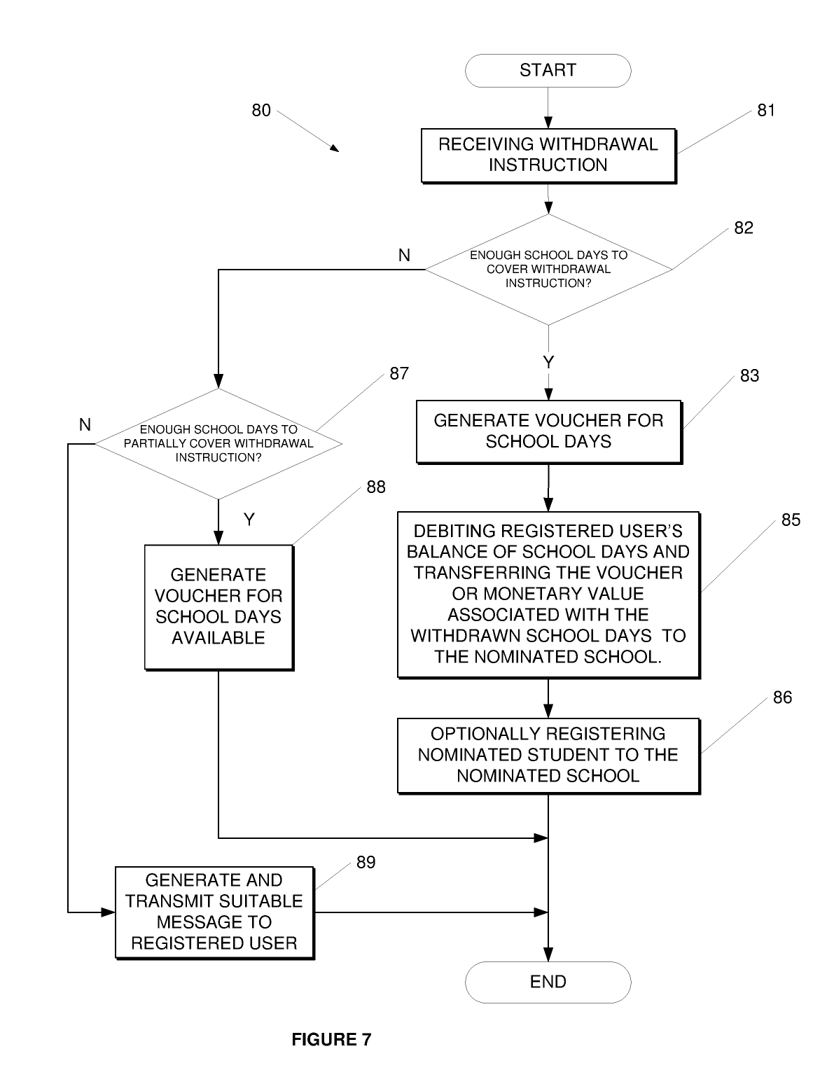

Referring now to FIG. 7 of the drawings where another method in accordance with an example embodiment is generally indicated by reference numeral 80. The method 80 may in one example embodiment be carried out by the module 40.

The method 80 comprises receiving, at block 81, from a user 14 via the website, a withdrawal instruction in a manner as described above for withdrawal of purchased or generated school days (e.g., in the form of a bursary for a nominated school).

The method 80 comprises determining, at block 82, whether the user 14 has enough school days to cover the school days requested as per the withdrawal instruction.

If there are enough school days, the method 80 comprises generating, at block 83, a voucher for the withdrawn school days which may be used at the nominated school 16.

The method 80 then comprises debiting or subtracting from, at block 85, the balance of school days associated with the user 14 with the number of school days withdrawn and transferring the generated voucher or monetary value of the voucher to the nominated school 16.

The method 80 then comprises optionally registering, at block 86, the student to the nominated school 16 as hereinbefore mentioned.

If there are not enough school days, at block 82, the method 80 comprises determining, at block 87, whether there are enough school days to partially cover the withdrawal instruction.

If there are enough school days in the user's school day account to partially cover the withdrawal instruction, the method 80 comprises generating, at block 88, a voucher for the school days available and processing in a similar manner as described with reference to block 85. However, if there are not enough school days to partially cover the withdrawal instruction, the method 80 comprises generating and transmitting, at block 89, a suitable message to the user 14 informing them of the same.

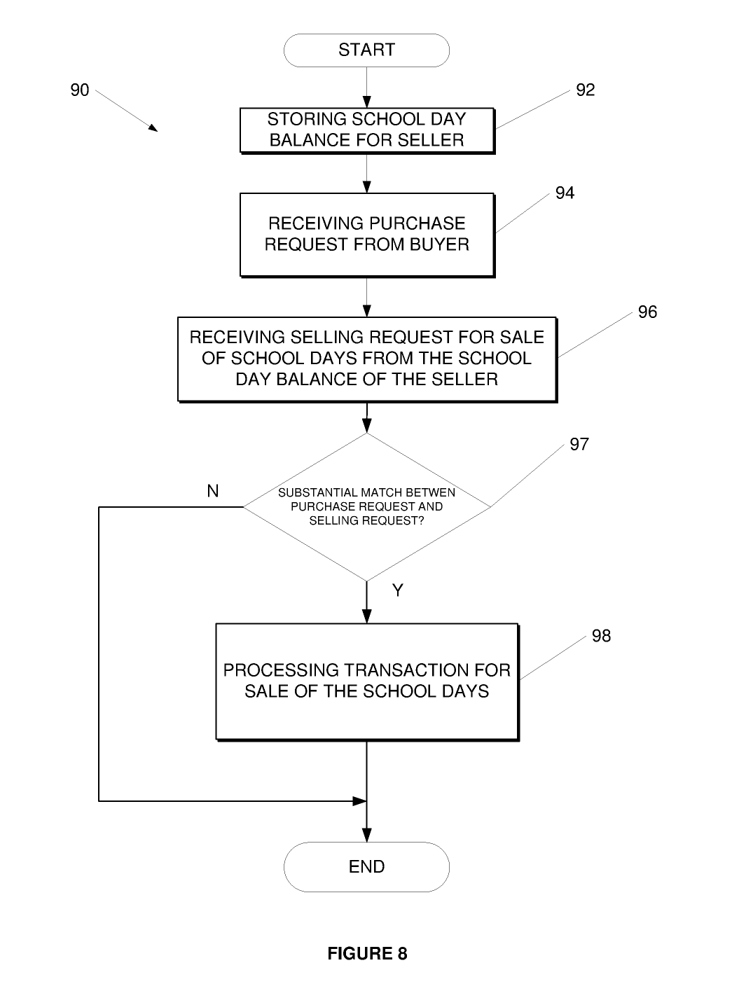

Referring to FIG. 8 of the drawings where yet another flow diagram of a method in accordance with an example embodiment is generally indicated by reference numeral 90. The method 90 may substantially be associated with the trading module 42 and may in one example embodiment be carried out by the module 42.

The method 90 comprises storing, at block 92 in the database 25, a school day balance associated with school days purchased for a school 16, or category thereof, by a seller.

The method 90 comprises receiving, at block 94, a purchase request/offer for purchase of school days for a particular monetary amount from a buyer.

The method 90 comprises receiving, at block 96, a selling request/offer for sale of a school day for a particular desired monetary amount by the seller.

The method 90 comprises determining, at block 97, whether there is a substantial match between a received purchase request and a received selling request in accordance with a predetermined rule set or as defined by requirements provided by both the buyer and seller.

If there is a substantial match, the method 90 may comprise processing, at block 98, the sale of the school days. The step at block 98 may be automatic on a match or may comprise informing the seller and purchaser of the match an processing the sale of the school days on receipt on instructions from the buyer and seller accordingly.

Processing the sale of school days may comprise the steps of debiting a school day balance of the seller in the database 24 and crediting a school day balance associated with the purchaser accordingly, wherein the monetary amount associated with the school days debited from the school day balance of the seller is transferred into a financial account at a financial institution associated with the seller.

It will be noted that the present invention does not constitute a mere savings scheme and is not a financial product. What the customer does is to purchase and accumulate time at educational institutions rather than build a savings fund that is expressed in financial terms. All elements of the product, whether they be accumulations through rebates from participating merchants, direct acquisitions, growth in portfolios or participation in the charitable element of the scheme, contribute to accumulation in the time that beneficiaries would be able to spend at chosen institutions. The time accumulated by the customer cannot be exchanged or redeemed for cash in any way: it may only be redeemed for tuition time at a chosen institution.

It follows that the system may be configured to generate and send statements to the registered users, which statements will not reflect a financial value to the portfolio. Instead, all expressions of value viewable or provided to the user would be in terms of accumulated tuition time at a chosen institution. The system will calculate the amount of this time based on the then current tuition time charges of the designated institution. In one example embodiment, invention operates in education points so that the accumulated time, or School-Days, can fluctuate according to the institution chosen. It will be appreciated that an institution with higher charges will reflect a lower amount of School-Days available. However, in keeping with the nature of the product as a time based acquisition rather than a financial one, the customer will continue to see value expressed as accumulated School-Days rather than anything else. This is an important component of the invention as is assists the customer to see and perceive the value in the system. In this regard, it will be noted that it is intrinsically easier and more meaningful for the customer to appreciate value expressed in time rather than financial terms: for example, it would be more meaningful for the customer to understand that he has 300 days out of 1000 provided for rather than simply value Rx.

In addition, it is important that the system convey this value to the customer relatively precisely, as they will also need to appreciate that redemption of the value of School-Days for tuition time at the institution is the only way that their stake in the system can be realised. This means that the product operates as a forced investment into education, as the customer cannot simply opt to “cash in” their School-Days and then use those proceeds for something entirely different, such as acquisition of other goods. As tuition time is the most costly single component of education, operating on this basis forces a particular behaviour and ensures that this critical aspect of raising children is covered.

Further, it will be understood that the system as described herein calculate a real time value of the School-Days at a particular institution that can be redeemed at any point.

Also, the present invention operates as an amalgamated product, in that the customer has four distinct tools at his disposal that can be used to increase the value of his School-Days. Thus the market tool (essentially merchant rebates expressed in the enrichment module), the accelerator tool (direct subscription contributions), the value tool (taking advantage of management of funds by external experts in the value growth programme) and the generosity tool (participating in a portion of system profits after making charitable contributions) all operate together to increase the value of the customer's School-Days.

The last mentioned aspect is important as the invention described herein is able to take the input of data from all four elements, perform the necessary calculations in terms of costs at the designated educational institution and produce a consolidated view of the total investment into educational time. This will solve the problem of the customer not having an immediate view into this overall value and will therefore simplify matters for the customer, which should provide further encouragement to set aside resources for education.

The invention also involves educational institutions that will go beyond the mere provision of information or acceptance of payment. It is envisaged the system may have preferential tariff structures with the educational institutions, which will result in the educational institutions effectively making contributions of School-Days into the customer's accounts which may then be redeemed once the beneficiary attends the institution in question. The contributions of School-Days by the educational institution would likely be conditional upon attendance by the beneficiary and would therefore not be redeemable at any other educational institution.

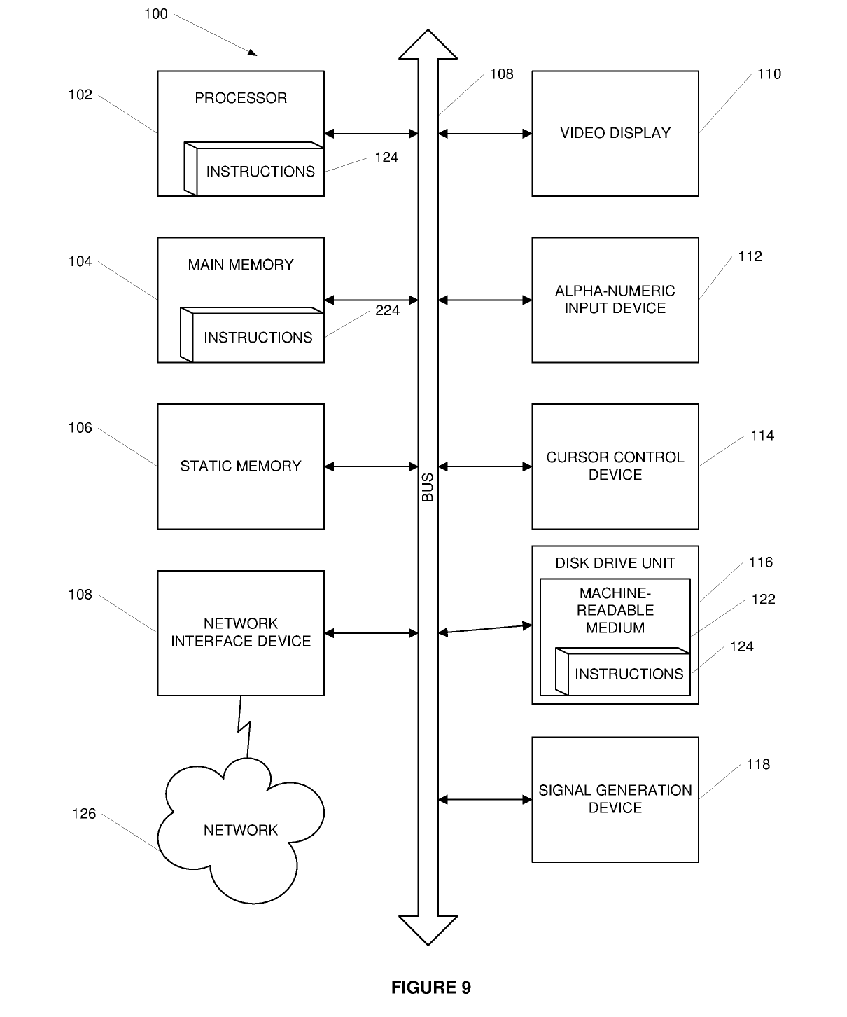

FIG. 9 shows a diagrammatic representation of machine in the example of a computer system 100 within which a set of instructions, for causing the machine to perform any one or more of the methodologies discussed herein, may be executed. In other example embodiments, the machine operates as a standalone device or may be connected (e.g., networked) to other machines. In a networked example embodiment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated for convenience, the term “machine” shall also be taken to include any collection of machines that individually or jointly execute a set (or multiple sets) of instructions to perform any one or more of the methodologies discussed herein.

In any event, the example computer system 100 includes a processor 102 (e.g., a central processing unit (CPU), a graphics processing unit (GPU) or both), a main memory 104 and a static memory 106, which communicate with each other via a bus 108. The computer system 100 may further include a video display unit 110 (e.g., a liquid crystal display (LCD) or a cathode ray tube (CRT)). The computer system 100 also includes an alphanumeric input device 112 (e.g., a keyboard), a user interface (UI) navigation device 114 (e.g., a mouse, or touchpad), a disk drive unit 116, a signal generation device 118 (e.g., a speaker) and a network interface device 120.

The disk drive unit 16 includes a machine-readable medium 122 storing one or more sets of instructions and data structures (e.g., software 124) embodying or utilised by any one or more of the methodologies or functions described herein. The software 124 may also reside, completely or at least partially, within the main memory 104 and/or within the processor 102 during execution thereof by the computer system 100, the main memory 104 and the processor 102 also constituting machine-readable media.

The software 124 may further be transmitted or received over a network 126 via the network interface device 120 utilising any one of a number of well-known transfer protocols (e.g., HTTP).

Although the machine-readable medium 122 is shown in an example embodiment to be a single medium, the term “machine-readable medium” may refer to a single medium or multiple media (e.g., a centralized or distributed database, and/or associated caches and servers) that store the one or more sets of instructions. The term “machine-readable medium” may also be taken to include any medium that is capable of storing, encoding or carrying a set of instructions for execution by the machine and that cause the machine to perform any one or more of the methodologies of the present invention, or that is capable of storing, encoding or carrying data structures utilised by or associated with such a set of instructions. The term “machine-readable medium” may accordingly be taken to include, but not be limited to, solid-state memories, optical and magnetic media, and carrier wave signals.

1. A method of operating an education transaction system, the method comprising:
storing, in a database, educator data associated with an education institution, or category of education institution, wherein the educator data comprises at least information indicative of education fees levied by the education institution, or category thereof;
receiving education time based information indicative of an amount of time at an education institution received by the system and/or monetary information indicative of a monetary amount received by the system, wherein the received time and/or monetary amount is associated with a registered user of the system;
receiving an education institution nomination request, from the registered user of the system, to select an education institution, or category thereof;
processing the received time and/or monetary information with the stored educator data associated with the selected education institution, or category thereof, to determine a configurable time period of education service, redeemable in the future, at the selected education institution, or category thereof, which the received monetary amount may purchase and/or received amount of time may acquire;
processing payment for and/or acquisition of the configurable time period; and
associating, in the database, the purchased and/or acquired configurable time period with the registered user, wherein the purchased and/or acquired configurable time period is not redeemable for a monetary sum by the registered user.

2. A method as claimed in claim 1, wherein the configurable time period is expressed as tuition or school days at an education institution, or category thereof, the method comprising:
maintaining, in the database, a school day balance for each registered user of the system, wherein the school day balance is indicative of an accumulated number of school days at the selected education institution or school, or category thereof; and
allocating purchased school days to the school day balance.

3. A method as claimed in claim 2, the method comprising converting school days from a first education institution to school days at a second education institution using stored educator data associated with the first and second education institutions, in response to a request therefore from the registered user.

4. A method as claimed in claim 2, the method comprising purchasing education points with the received monetary amount, which points are expressible in terms of school days.

5. A method as claimed in claim 1, wherein the educator data comprises education fees per annum, day, term, or month at the education institution, or category thereof.

6. A method as claimed in claim 2, the method comprising the step of calculating daily education fees at each education institution, or category thereof, by dividing the fees levied for a particular period by the education institution, or average fees levied for a particular period by the category of education institution, by the number of active school days in the said particular period, wherein the active days excludes weekends, public holidays, and breaks.

7. A method as claimed in claim 6, wherein processing the received monetary information comprises dividing a monetary value, associated with the monetary amount received, by daily education fees of the selected education institution, or category thereof, thereby to determine the number, or portion, of school days which the received monetary amount may purchase at the education institution, or category thereof.

8. A method as claimed in claim 2, wherein the configurable time periods, or school days, are conceptual periods of time of education or tuition generated and maintained by the system which correspond to, and are redeemable for, corresponding periods of education or tuition time, at selected education institutions

9. A method as claimed in claim 2, the method comprising aggregating school days in the school day balance for a registered user for monetary amounts received.

10. A method as claimed in claim 2, the method comprising a step of generating a voucher for school days at a particular education institution, or category thereof, on receipt of a suitable withdrawal or redemption instruction from the registered user to redeem school days.

11. A method as claimed in claim 10, the method comprising debiting the registered user's balance of school days accordingly and automatically transferring a monetary amount associated with the generated voucher for school days to the education institution.

12. A method as claimed in claim 11, the method comprising transmitting a suitable payment advice to the education institution and optionally registering a nominated student for the number of school days as per the generated voucher.

13. A method as claimed in claim 2, the method comprising receiving a monetary amount associated the registered user by two or more of receiving a periodic premium from the registered user directly, receiving a monetary amount via an authorised retailer, wherein the authorised retailer apportions a portion of a spend made by the registered user to the authorised retailer to the system, interest earned on the monetary amount paid for the purchased school days, receiving a discount from the education institution, and receiving a monetary amount from a secondary registered user.

14. A method as claimed in claim 1, the method comprising receiving and storing educator data for each educational institution on a periodic basis and/or in response to an increase in fees levied by the education institutions.

15. A method as claimed in claim 2, the method comprising:
using current educator data to determine the amount to school days held at a particular school at present substantially in real-time; and/or
determining inflation adjusted educator data associated with a school at a date or year of redemption of school days, using the inflated educator data to determine the amount of school days held at present associated with the date or year of redemption in the future.

16. A method as claimed in claim 2, the method comprising generating one or more school days in response to registered users transacting with authorised retailers, which school are accruable to the school day balance associated with the registered user.

17. A method as claimed in claim 2, wherein the school day, particularly the monetary amount paid therefor, is invested into an investment or an investment vehicle.

18. A method as claimed in claim 2, the method comprising making the school day balance available for viewing by the user via a suitable user interface means.

19. A method as claimed in claim 2, the method comprising receiving a beneficiary selection from the registered user indicative of the recipient of the school days.

20. An education transaction system comprising:
a database storing educator data associated with at least one education institution, or category of education institution, wherein the educator data comprises at least information indicative of education fees levied by the education institution, or category thereof;
a selection module configured to receive an education institution nomination request, from a registered user of the system, to select an education institution, or category thereof;
a cash collections module configured to receive monetary information indicative of a monetary amount associated with the registered user;
a conversion processing module configured to process the received monetary information with the stored educator data associated with the selected education institution, or category thereof, to determine a configurable time period of education service, redeemable in the future, at the selected education institution, or category thereof, which the received monetary amount may purchase; and
an associating module configured to associate in the database, the purchased configurable time period with the registered user, wherein the purchased configurable time period is not redeemable for a monetary sum by the registered user.

21. A system as claimed in claim 20, the system comprising an education registration module configured to receive and store, in the database, educator data associated with a plurality of education institutions, or categories thereof.

22. A system as claimed in claim 20, wherein the configurable time period is expressed as tuition or school days at an education institution, or category thereof, wherein:
the database stores a school day balance for each registered user of the system, wherein the school day balance is indicative of an accumulated number of school days at the selected education institution or school, or category thereof; and
the association module is configured to allocate purchased school days to the school day balance stored in the database.

23. A system as claimed in claim 22, wherein the educator data comprises education fees per annum, term, or month at the education institution, or category thereof.

24. A system as claimed in claim 21, wherein the education registration module is operable to calculate the effective daily education fees at each education institution, or category thereof, by dividing the fees levied for a particular period by the education institution, or average fees levied for a particular period by the category of education institution, by the number of active school days in the said particular period, wherein the active days excludes weekends, public holidays, breaks, and the like.

25. A system as claimed in claim 24, wherein the conversion processing module is configured to process the received monetary information by dividing a monetary value, associated with the monetary amount received, by the effective daily education fees of the selected education institution, or category thereof, thereby to determine the number, or portion, of school days which the received monetary amount may purchase, at the education institution, or category thereof.

26. A system as claimed in claim 22, the system comprising a user registration and management module operable to facilitate registering a user to the system and storing received information associated therewith in a registered user profile and/or maintain the school day balance for a particular registered user in the database.

27. A system as claimed in claim 26, wherein the user registration and management module is configured to aggregate school days in the school day balance for a registered user for monetary amounts received.

28. A system as claimed in claim 22, the system comprising a redemption module operable to generate a voucher for school days at a particular education institution, or category thereof, on receipt of a suitable withdrawal or redemption instruction from the registered user to redeem school days.

29. A system as claimed in claim 28, wherein the redemption module is configured to debit the school day balance of the registered user and automatically transfer a monetary amount associated with the generated voucher for school days to the education institution, optionally advising any parties of any time provision obligations in the process.

30. A system as claimed in claim 28, wherein the redemption module is operable to transmit a suitable payment advice to the education institution and optionally register a nominated student for the number of school days as per the generated voucher.

31. A system as claimed in claim 22, the system comprising an enrichment module configured to receive information indicative of a monetary amount received from a registered user via an authorised retailer, wherein the authorised retailer apportions a portion of a spend made by the registered user to authorised retailer, to the system.

32. A system as claimed in claim 31, wherein the enrichment module is operable to use the conversion processing module to generate one or more school days in response to registered users transacting with authorised retailers, the school days being accruable to the school day balance of the registered user.

33. A system as claimed in claim 31, wherein the enrichment module is configured to invest the monetary amounts received for the purchase of the school days, into one or more conventional financial vehicles.

34. A system as claimed in claim 20, wherein the system is for the pre-purchase of education services at a school, a university, and a college.

35. A system as claimed in claim 22, the system comprising a user interface means configured to provide the registered user with information indicative of their school day balance in response to a received request therefor.

36. A method comprising:
storing, in a database, a school day balance associated with school days purchased for an education institution, or category thereof, by a seller;
receiving a purchase request for purchase of school days for a particular monetary amount from a buyer;
receiving a selling request for sale of a school day for a particular desired monetary amount by the seller;
matching substantially a received purchase request and a received selling request in accordance with a predetermined rule set; and
in response to a substantial match being agreed to by the buyer and seller, processing the sale of the school days.

37. A method as claimed in claim 37, wherein processing the sale of school days comprises the steps of debiting a school day balance of the seller in the database and crediting a school day balance associated with the purchaser accordingly, wherein the monetary amount associated with the school days debited from the school day balance of the seller is transferred into a financial account at a financial institution associated with the seller.
